(19) United States
(12) Patent Application Publication
(10) Pub. No.: US 2026/0091808 A1
(43) Pub. Date: Apr. 2, 2026

(54) METHOD FOR CONTROLLING A ROBOTIC APPARATUS

(71) Applicant: Robert Bosch GmbH, Stuttgart (DE)

(72) Inventors: Jens Oehlerking, Stuttgart (DE); Johannes Christian Mueller, Stuttgart (DE); Stefan Aulbach, Renningen (DE); Steffen Knoop, Hohenwettersbach (DE); Wolfgang Branz, Ludwigsburg (DE)

(21) Appl. No.: 19/337,996

(22) Filed: Sep. 24, 2025

(30) Foreign Application Priority Data
Oct. 1, 2024 (DE) 10 2024 209 617.2

(51) Int. Cl. B60W 60/00

(52) U.S. Cl. CPC B60W 60/0016; B60W 2556/10; B60W 2556/40; B60W 2556/45

(57) ABSTRACT

A method for controlling a robotic apparatus. The method includes ascertaining a domain of observations made during subcritical events, from observations of controls from a control data database; ascertaining a criterion using which a limitation of the probability of occurrence of a critical event can be inferred from a limitation of the probability of occurrence of a subcritical event; ascertaining further observations when controlling the robotic apparatus, and ascertaining a relative frequency of those of the further observations that are in the ascertained domain; checking whether the ascertained relative frequency corresponds to a probability of occurrence of a subcritical event that is limited in such a way that a limitation of the probability of occurrence of a critical event can be inferred therefrom according to the criterion; and triggering a safety measure in response to the ascertained frequency not corresponding to a probability of occurrence of the subcritical event.

### CROSS REFERENCE

The present application claims the benefit under 35 U.S.C. § 119 of Germany Patent Application No. DE 10 2024 209 617.2 filed on Oct. 1, 2024, which is expressly incorporated herein by reference in its entirety.

### FIELD

The present invention relates to methods for controlling a robotic apparatus.

### BACKGROUND INFORMATION

When controlling a robotic apparatus in a control situation, there are risks of accidents, such as with other road users when controlling an at least partially automated vehicle in road traffic or with a human user who is near a robotic arm that is being controlled. Whether accidents occur can depend on various factors, in particular on the behavior of the other road users and on whether the control system detects the control situation correctly and responds correctly thereto. In order to provide safety guarantees, control systems must be tested, which is very time-consuming. Accordingly, approaches are desirable that make it possible, when controlling a robotic apparatus, to keep the risk of accidents within a tolerable range or to keep the testing effort required to guarantee that a robotic apparatus is controlled safely to a minimum.

### SUMMARY

According to various embodiments of the present invention, a method for controlling a robotic apparatus is provided, comprising:
ascertaining a domain of observations made during subcritical events, from observations of controls performed in corresponding control situations, from a control data database,
ascertaining, from the observations from the control data database, a criterion by means of which a limitation of the probability of occurrence of a critical event can be inferred from a limitation of the probability of occurrence of a subcritical event,
ascertaining further observations when controlling the robotic apparatus, and ascertaining a relative frequency of those of the further observations that are in the ascertained domain,
checking whether the ascertained relative frequency corresponds to a probability of occurrence of a subcritical event that is limited in such a way that a limitation of the probability of occurrence of a critical event can be inferred therefrom according to the criterion, and
triggering a safety measure in response to the ascertained frequency not corresponding to a probability of occurrence of a subcritical event that is limited in such a way that a limitation of the probability of occurrence of a critical event can be inferred therefrom according to the criterion.

The method described above may make it possible to guarantee the safety of a control or to take safety measures if this is not possible, and thus to achieve a high level of safety without the need to extensively test the system (robotic apparatus and its control device), since the observation of subcritical events (i.e., observations made during controls (i.e., control processes) in which subcritical events occur) during operation is also sufficient. The system therefore does not need to be tested over a long period of time to ensure that no critical event (e.g., damage event) occurs, since the probability of occurrence of the critical events is estimated on the basis of a relative frequency of subcritical events (e.g., near-miss events) and the occurrence of subcritical events is tolerable during operation. If the ascertained relative frequency shows that the probability of occurrence of critical events is high (i.e., if the probability of occurrence of the subcritical events is too high to be able to limit the probability of occurrence of critical events), a safety measure is triggered. Since subcritical events occur relatively frequently, the operating conditions are in a statistically comfortable range, which makes it possible to achieve a sufficiently high level of confidence. In other words, online monitoring is performed using information about previous controls (i.e., offline data), which makes it possible to achieve a high level of confidence of the online monitoring.

According to one example embodiment of the present invention, the current observations in the online system are compared with the already existing empirical values (offline data). As soon as there is reason to assume that the safety of the online system is not sufficient, a safety measure is triggered. In the simplest case, the relative frequency of subcritical events is considered: If this frequency is (significantly) higher in the online system than in the offline data, a safety measure is triggered since it is assumed that, in this case, the critical events also occur more frequently than predicted by the offline data. Since subcritical events occur significantly more frequently than critical events, relatively few observations in the online system are required to perform this comparison. The more data the online system has already collected, the more detailed the comparison with the offline data can be, up to the extrapolation of the frequency of critical events in the online system and the subsequent comparison with the frequency resulting from the offline data.

A subcritical event is an event that is almost critical and thus allows conclusions to be drawn about the probability of a critical event. With respect to road traffic, a subcritical event is, for example, a near miss.

Various exemplary embodiments of the present invention are specified below.

Exemplary embodiment 1 is a method for controlling a robotic apparatus, as described above.

Exemplary embodiment 2 is a method according to exemplary embodiment 1, wherein the criterion is a conditional probability (denoted by P(A|B) in the example below) that a critical event (A) occurs when a subcritical event occurs (B). This means that, according to equation (1) below, a limitation of the probability of occurrence of a critical event can be inferred from a limitation of the probability of occurrence of a subcritical event (denoted by P(B) above).

This makes it possible to reliably infer a limitation of the probability of occurrence of critical events, provided that the probability of occurrence of subcritical events is sufficiently limited. The conditional probability can be ascertained on the basis of a probability distribution (e.g., by fitting a probability model) for data from the control data database. For example, in the form of a probability distribution that can be represented with the x-axis as the risk metric and the y-axis as the probability of occurrence or probability density of the underlying distribution. In this case, x-axis ranges of medium risk (subcritical events) and of high risk (critical events) can be defined and P(A), P(B), and P(A|B) can be ascertained therefrom. With this approach, it is not necessary for data on control with critical events to exist in the control data database: By means of a long-tail fit, for example, the probability distribution (for which such an approach is justified, e.g., a (generalized) Pareto distribution) can be completely estimated using only data with lower risk.

Exemplary embodiment 3 is a method according to exemplary embodiment 2, comprising ascertaining the conditional probability from a distribution of critical events and subcritical events across the controls for which the control data database contains data.

The criterion can thus be ascertained from existing data, e.g., from data on tests of similar systems (e.g., previous versions of the robotic apparatus and/or its control), without having to test the (current) system until damage events occur (or until it can be ensured that the damage events occur only extremely rarely).

Exemplary embodiment 4 is a method according to exemplary embodiment 2 or 3, comprising a subjective logic opinion from the relative frequency, wherein the criterion is a criterion regarding the subjective logic opinion and depending on the conditional probability.

See equation (2) below for an example. By means of subjective logic, the epistemic uncertainty can be explicitly taken into account.

Exemplary embodiment 5 is a method according to exemplary embodiment 1, wherein the observations from the control data database do not contain any observations for critical events (i.e., the observations are, for example, selected from the control data database such that they do not contain any observations for controls in which critical events have occurred) and the criterion is that the ascertained relative frequency does not exceed, by more than a specified tolerance (which may also be zero), a relative frequency with which the observations from the control data database contain observations for subcritical events.

This allows for a very simple estimation of the probability (of occurrence) of critical events.

Exemplary embodiment 6 is a method according to one of exemplary embodiments 1 to 5, comprising ascertaining the domain of observations made during subcritical events by mapping the observations into a (latent) feature space (i.e., onto latent observation representations) and ascertaining a domain (e.g., on the basis of threshold values for one or more different vector components) of the feature space into which observations made during subcritical events are mapped, and ascertaining a relative frequency of those of the further observations (i.e., the relative frequency of those of the observations that are in the ascertained domain among the observations made during operation) that are in the ascertained domain by mapping the further observations into the feature space and ascertaining the relative frequency of those of the further observations that are mapped into the ascertained domain of the feature space.

In particular for observations that have many components (e.g., a (total) observation contains multiple (partial) observations about the particular control situation, the behavior of an object detector, of a planning module, etc.), this allows for a simple assignment of observations to domains, i.e., a classification of observations that correspond to normal, critical, or subcritical events, i.e., are made during such events. The domain of observations made during subcritical events can be considered as the preimage of the ascertained domain of the feature space (according to the used mapping of observations into the feature space). However, ascertaining whether observations fall into the domain is simply done in the feature space (i.e., the preimage does not need to be ascertained).

Exemplary embodiment 7 is a method according to one of exemplary embodiments 1 to 6, wherein the robotic apparatus is a vehicle, and the control situation is a traffic situation.

Exemplary embodiment 8. Data processing system configured to perform a method according to one of exemplary embodiments 1 to 7.

Exemplary embodiment 9 is a computer program comprising commands that, when executed by a processor, cause the processor to perform a method according to one of exemplary embodiments 1 to 7.

Exemplary embodiment 10 is a computer-readable medium storing commands that, when executed by a processor, cause the processor to perform a method according to one of exemplary embodiments 1 to 7.

In the figures, similar reference signs generally refer to the same parts throughout the various views. The figures are not necessarily true to scale, with emphasis instead generally being placed on the representation of the principles of the present invention. In the following description, various aspects are described with reference to the figures.

### BRIEF DESCRIPTION OF THE DRAWINGS

FIG. 1 shows a vehicle (as an example of a robotic apparatus that is controlled).

FIG. 2 illustrates a control pipeline according to an example embodiment of the present invention.

FIG. 3 illustrates monitoring of a control according to an example embodiment of the present invention.

FIG. 4 shows a flowchart, which represents a method for controlling a robotic apparatus according to an example embodiment of the present invention.

### DETAILED DESCRIPTION OF EXAMPLE EMBODIMENTS

The following detailed description relates to the figures, which show, by way of explanation, specific details and aspects of this disclosure in which the present invention can be executed. Other aspects may be used, and structural, logical, and electrical changes may be performed without departing from the scope of protection of the present invention. The various aspects of this disclosure are not necessarily mutually exclusive, since some aspects of this disclosure may be combined with one or more other aspects of this disclosure to form new aspects.

Various examples are described in more detail below.

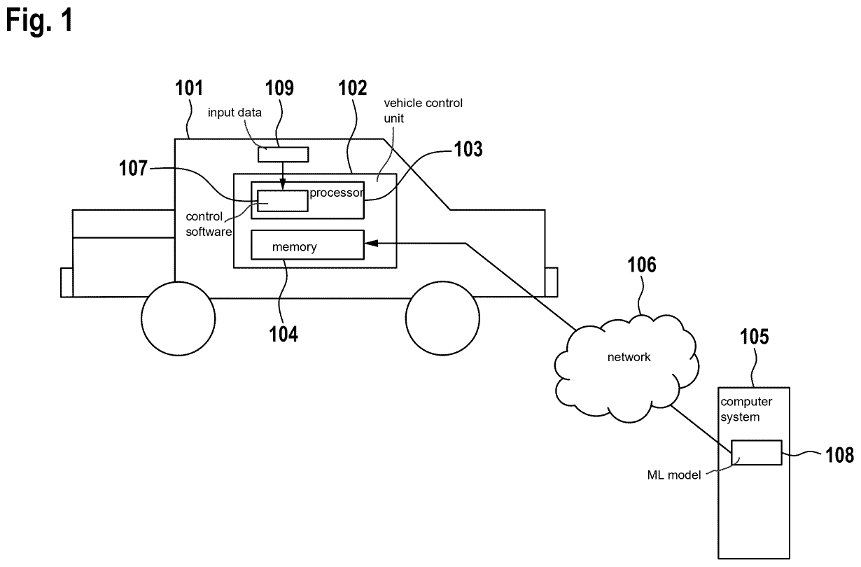

FIG. 1 shows a vehicle 101.

In the example of FIG. 1, a vehicle 101, for example a motor vehicle such as a passenger car or truck, is provided with a vehicle control unit (for example, an electronic control unit (ECU)) 102.

The vehicle control unit 102 comprises data processing components, for example a processor (for example, a CPU (central processing unit)) 103 and a memory 104 for storing control software 107 according to which the vehicle control unit 102 operates, and data that are processed by the processor 103. The processor 103 executes the control software 107 (it is therefore shown in FIG. 1 as part of the processor 103).

For example, the stored control software (computer program) comprises instructions that, when executed by the processor, cause the processor 103 to execute driver assistance functions or even to control the vehicle autonomously.

The control software 107 is, for example, transmitted to the vehicle 101 from a computer system 105, for example via a network 106 (or by means of a storage medium such as a memory card). This can also take place in operation (or at least when the vehicle 101 is with the user) since the control software 107 is updated over time to new versions, for example.

The control software 107 can, for example, be trained using machine learning (ML), i.e. the control software 107 implements one or more ML models 108 (or machine learning model), which is trained based on training data, in this example by the computer system 105. The computer system 105 thus implements an ML training algorithm for training the one or more ML models 108, which are used for object recognition (e.g., other road users), for example.

The vehicle 101 is at least partially automated. The control software 107 carries out one or more driving functions (e.g., fully autonomous driving) by ascertaining control actions for the vehicle (such as steering actions, braking actions, etc.) from input data 109 that are available to it and that contain information about the environment or from which it derives information about the environment, i.e., detects the traffic situation (such as by detecting other road users, e.g., other vehicles), and controlling components of the vehicle accordingly. The input data 109 are, for example, sensor data such as information obtained from a camera of the vehicle or via communication with other vehicles or external apparatuses on the roadside.

Driving functions of at least partially automated vehicles (level 1 to level 5) require ever greater complexity as the range of functions increases. The driving functions often have a modular design so that uncertainties accumulate along the corresponding processing chain (processing of sensor data to detect a traffic situation, assessing the traffic situation, planning by a planning module, ascertaining the control actions, etc.) and can ultimately lead to an incorrect decision. In the course of ISO 21448 Safety of the Intended Functionality (SOTIF), it becomes mandatory not only to exclude input/output errors (ISO 26262) but also to counteract functional deficiencies.

For releasing driving functions of at least partially automated vehicles for use in road traffic, large amounts of data are necessary in order to be able to guarantee their safety (except for a residual risk (i.e., a residual risk probability), which is typically very low). Such data must be generated through cost-intensive and lengthy operation of the vehicle, i.e., the particular system under test, and repeated for each product generation. A core problem for the need for such comprehensive offline verification (OV) is that the assumptions made in the safety argumentation must be verified for every possible case.

The following describes an approach to controlling vehicles (or robotic apparatuses in general, wherein the control does not need to be fully autonomous but can also be a support to a user, such as a driver assistance system) that makes it possible to reduce the necessary OV effort required to comply with specified risk constraints.

This is achieved by using a (computer-implemented) method for the online assessment of system capabilities (i.e., the performance capability of the particular controlled robotic apparatus including the performance capability of its control) in a given (current) control situation, wherein the assessments ascertained are used as observations with which the probability (of occurrence) of a critical event (e.g., a damage event) is inferred.

For this purpose, a proxy hypothesis is formulated instead of assumptions that were previously made (or postulated) in the safety argumentation (i.e., the derivation that a certain level of safety (except for a residual risk) can be guaranteed) and would therefore have to be confirmed with great effort by means of OV. For this hypothesis, one or more test criteria are formulated, on the basis of which this hypothesis can be supported or refuted at runtime (i.e., during operation of the robotic apparatus (i.e., online)). If the proxy hypothesis cannot be sufficiently supported at runtime (on the basis of observations or, in other words, statistical evidence) or is even refuted by contradictory observations, the proxy hypothesis is rejected and, accordingly, it is no longer assumed that safety (in the current operating mode) can be guaranteed.

The assessment (e.g., on the basis of statistical evidence) is generated on the basis of observations such as sensor data (measurements) or variables derived therefrom, wherein error rates of the sensors can be included by appropriately weighting other observations (or the evidence derived therefrom).

As mentioned above, rejecting the proxy hypothesis has the result that it is no longer assumed that safety (in the current operating mode) can be sufficiently guaranteed. This means that a risk-mitigating system response is triggered. For example, this may involve falling back to a more conservative set of assumptions (and accordingly less risky control) or other types of control with lower risk, such as, in the case of a vehicle, reducing the speed, increasing safety distances and margins, or, in particular for L2 or L3 systems, handing over to the human driver (TOR for take-over request).

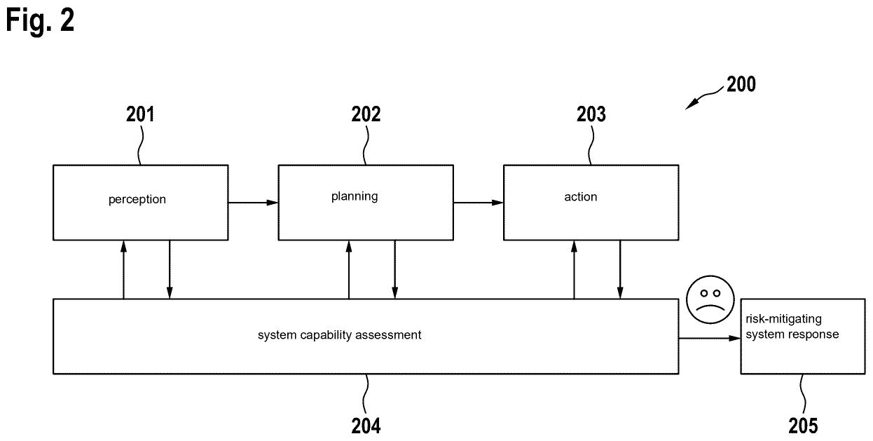

FIG. 2 illustrates a control pipeline 200 with system capability assessment 204 (SCA) and, depending on the assessment, triggering of a safety measure (i.e., a risk-mitigating system response) 205 (in this example, a TOR). The assessment (or multiple assessments, e.g., over a time window) can be regarded as one observation.

The SCA 204 (i.e., a corresponding function or module, e.g., of the vehicle control device 102 or of the control device of another robotic apparatus, e.g., a robotic arm) interacts with all blocks of the control pipeline that implements a chain of perception 201, planning 202, and action (i.e., generation of control signals, e.g., for actuators), for example in the form of corresponding modules that are implemented, for example, by the vehicle control device 102 or the control device of a particular other robotic apparatus. This interaction may include feedback from SCA 204 to the modules 201, 202, 203, e.g., as part of the risk-mitigating system response.

The perception 201 (i.e., the detection of the control situation in which the particular robotic apparatus is) is monitored (i.e., observed) to see whether it complies with the requirements placed on it. For example, a requirement (and correspondingly a hypothesis that it is fulfilled) may be that the perception 201 recognizes all relevant objects in the control situation. This hypothesis can be supported, for example, by the detected objects being classified consistently, by the object list for the current time according to the motion model being consistent with past object lists, and by redundant sensors detecting the particular objects consistently. Planning 202 is monitored to ensure that it fulfills the planning assumptions and requirements. For this purpose, a method can be used that explicitly provides assumptions that were made in the planning and under which the planning result is formally guaranteed to be safe. For the monitoring (i.e., observation) of the action 203, the SCA 204 essentially checks the assumption that the behavior that is determined according to the particular abstraction model during planning 202 and which can be represented, for example, in the form of a trajectory, is implemented within specified tolerances. For this purpose, hypotheses can again be formulated and checked. In addition to consistency and plausibility checks, the SCA 204 can also access self-diagnosis metrics of the individual modules in order to collect statistical evidence for or against the particular hypotheses (or observations relevant to them).

When using a system capability assessment to reduce the required OV data, the particular challenge arises that the permissible residual risk probabilities are often extremely small (e.g., less than 10-9). Accordingly, it is expected that possible damage events are extremely rare and that a large number of observations must be collected in order to sufficiently support the particular hypotheses (on which the safety guarantees are based) so that they can be accepted.

According to various embodiments, a proxy hypothesis is therefore generated on the basis of system knowledge and statistical information from observations from previous control processes, which are obtained, for example, from OV data of previous product generations, and is then used as a basis for extrapolating the actual residual risk probability (of a risk in current operation, i.e., when controlling the particular robotic apparatus).

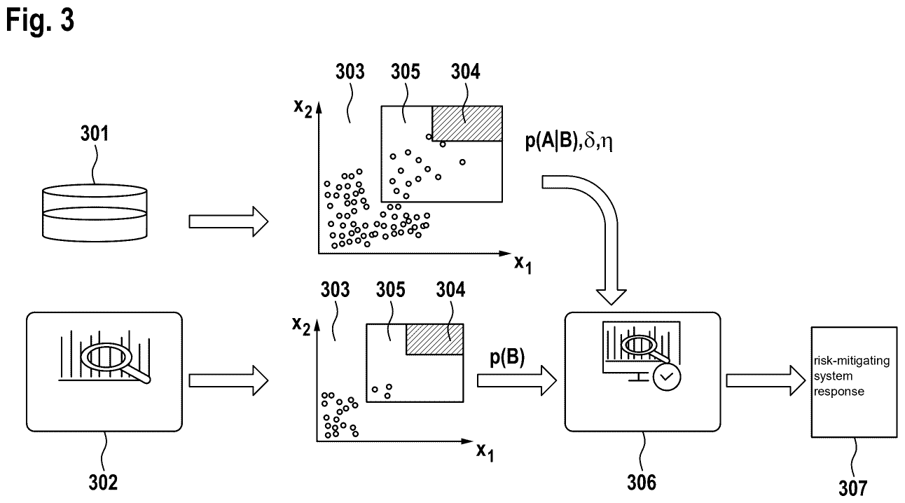

FIG. 3 illustrates monitoring of a control (i.e., a control process) according to an embodiment.

Observations from a control data database (e.g., a database with OV data) 301 and observations 302 (i.e., statistical evidence) collected in current operation are first transformed into a feature space 303 by means of system knowledge and metrics derived therefrom. For example, a (total) observation (which may be a set of (partial) observations) is made, e.g., over a specific time window, which may contain observations about the current control situation (e.g., a time to collision with a recognized object) and/or observations regarding the control pipeline 200, such as the result of a plausibility test of an object recognition during the perception 201, etc., and is mapped to a vector in the feature space 303. This mapping is carried out by ascertaining features of the particular sets of observations, e.g., by means of an encoder (possibly trained on machine learning) or by ascertaining various criticality metrics, the values of which then form the values of the components of the vector in the feature space 303. Where appropriate, an aggregation (e.g., a temporal aggregation) can also be included in this mapping. The vector in the feature space thus obtained for a (total) observation is referred to below as the (latent) observation representation.

In this feature space, the domain corresponding to (rare) critical events (damage events) can now be marked (e.g., on the basis of the observation representations for observations from the control data database 301, which can also contain damage events, for example), i.e., the domain of the feature space 303 containing the vectors can be mapped onto the observations made during a damage event. This domain is referred to below as (latent) damage domain 304.

In addition, the distance of collected observations (i.e., sets of observations or their observation representations) to the damage domain (and thus to a particular damage event) and thus sets of observations made during near-miss events (subcritical events, so-called close calls) can be identified in the feature space. These are sets of observations of which the observation representations are in some sense close to the damage domain, e.g., above a specified threshold value, which is chosen depending on the design of the feature space. A near-miss event is a subcritical situation, i.e., for example, a situation in which the distance between two vehicles was very small, but a collision had not yet occurred (if a collision occurs, the situation was “critical”). The threshold value can be chosen such that the distance of the observation representations of such near-miss events to the damage domain is less than the threshold value. The domain of observation representations for observations that occurred in near-miss events (e.g., in controls for which the control data database 301 contains data) is referred to as the (latent) near-miss domain 305.

As explained above, a guarantee that no damage event occurs (or at least sufficiently few damage events occur, i.e., damage events are very unlikely) can be made on the basis of an assumption (hypothesis) HA, which can contain multiple sub-assumptions (e.g., the assumption that the perception 201 is carried out correctly, and assumptions about the planning 202 and about the action 203, see above). Whether a hypothesis is fulfilled or not is indicated by the system capability assessment ascertained by the SCA 204. Similarly, the guarantee that sufficiently few near-miss events occur can now be assigned a hypothesis (“HB”), which, if proven, guarantees that no near-miss event occurs (except for a residual risk).

Whether HB is fulfilled or not can also be indicated by the system capability assessment ascertained by the SCA 204. According to various embodiments, such a hypothesis HB is used as a proxy hypothesis.

In other words, the SCA 204 first assesses the extent to which the proxy hypothesis HB is fulfilled, and then extrapolates the actual hypothesis HA. The (probabilistic) guarantee then also primarily relates to the hypothesis HA and not the proxy hypothesis HB. In order for HA to be guaranteed, HB must be fulfilled to an appropriate extent. This is monitored by the SCA 204 and appropriate countermeasures are initiated if HB is violated. Thus, HB can be violated, but not over multiple time steps.

The criteria for defining the near-miss events are chosen such that
there is a strong correlation or, if possible, even a causal connection between the near-miss event and the potential damage event,
the expected relative frequency of near-miss events is sufficiently high in order to be able to collect sufficient observations (and thus statistical evidence) quickly during operation (i.e., at runtime) in order to be able to confirm the proxy hypothesis corresponding to the near-miss events, and
the particular existing data in the control data database 301 can be used to determine the extrapolation from the probability of occurrence of a near-miss event to the probability of occurrence of the damage event sufficiently precisely so that an ascertainment 306 that the probability of occurrence of the damage event is below a threshold can be performed if the probability of occurrence of a near-miss event can be limited.

Confirming a proxy hypothesis means that the possibility that the proxy hypothesis is not valid can be narrowed down to a sufficiently small domain.

The definition of the near-miss events is a problem-specific trade-off decision since the expected frequency of near-miss events decreases sharply with their criticality. In some exemplary embodiments, the near-miss events may well have a low criticality. For extrapolation, for example, the estimated distribution of the damage events can be used, as explained below.

In a simple embodiment, the extrapolation can be represented as a conditional probability. For this purpose, let “A” be a damage event (i.e., the event that any damage occurs) and “B” be the near-miss event (i.e., the event that any subcritical situation occurs, where A is a subset of B because every damage event is preceded by a subcritical situation; for example, the distance between two vehicles must have become dangerously small before it truly becomes zero).

Accordingly,

$$p ( A ) = p ( A ⋂ B ) = p ( A \vert B ) p ( B ) \qquad ( 1 )$$

is the probability that A occurs, p(A|B) is the conditional probability that A occurs, given that B has occurred, and p(B) is the probability that B occurs. For p(A|B), an upper bound is determined from the data of the control data database 301 and, on the basis of the accepted probability of occurrence of p(A)<ϵ, a bound p(B)<δ and a statistical confidence n that p(A)<ϵ is fulfilled are determined according to equation (1).

It should be noted in this context that, as mentioned above, the hypotheses HA and HB can be defined so that
if HA applies, p(A)<ϵ applies and
if HB applies, p(B)<δ applies

According to various embodiments, however, p(B)<δ is then used as a proxy hypothesis for p(A)<ϵ since, by definition, if p(B)<δ, then p(A)<ϵ, i.e., except for the residual probability ϵ, no damage will occur.

During operation (i.e., at runtime), observations (and thus statistical evidence) are then collected in order to prove that p(B)<δ, which can be carried out by proving HB or by attempting to refute HB. If the proxy hypothesis p(B)<δ can be proven with the necessary confidence, it will be accepted. Otherwise, a risk-mitigating system response is initiated (since p(A)<ϵ then cannot be argued).

The transferability of the probability determined from the data of the control data database 301 to the system under test results from the fact that, on the basis of system knowledge, a causal connection with a linked stochastic process between the proxy hypothesis and the damage event was derived, which was only probabilistically quantified on the basis of the data from the control data database 301. Provided that the underlying causal connection has not changed, the conditional probability also remains the same.

According to various embodiments, subjective logic is used to evaluate the statistical evidence collected at runtime and thus to infer the trust of the current system capabilities (and thus to infer that the proxy hypothesis is fulfilled). The advantage of Subjective Logic for this application is, among other things, that the statistical uncertainty is explicitly included in the statement and that prior knowledge can explicitly be included and, if it changes, can be adjusted at any time.

As explained above, a risk-mitigating system response 307 is carried out depending on whether the ascertainment 306 ascertains that the proxy hypothesis is fulfilled. This system response may include feedback to the components of the control pipeline 200: For the perception 201, this may be a change in the algorithms used, for the planning 202, the fallback to more conservative prediction models, and for the action 203, the change to more conservative control parameters. For L3 systems, for example, a TOR 205 is triggered as described above.

In the example of FIG. 3, the feature space 303 is a metric space with two dimensions x₁ and x₂. These two dimensions can, for example, correspond to the values of two criticality metrics or the values of a technical performance indicator (hereinafter collectively referred to as “metrics”). These metrics reflect system knowledge, which may originate from a similar system (e.g., previous generation of the system under test), and make it possible to map a set of observations into the feature space 303. In this feature space, the damage domain 304 and the near-miss domain 305 are then marked as explained above.

The number of dimensions of the feature space 303 Is chosen, for example, depending on the complexity of the damage event (or its possible occurrence) against which safeguards are to be provided.

For example, by means of an extreme value methodology, the conditional probability p(A|B) is estimated on the basis of the data from the control data database 301 (which are obtained, for example, by operating and observing a system similar to the system under test) (and can then be used to ascertain P(A) according to equation (1)):
The set of near-miss events is in this case defined as a set of (sub)critical situations by defining a (sub)critical threshold value for each dimension, above which threshold value the associated metric has a (sub)critical value. FIG. 3 shows the case in which the near-miss domain 305 corresponds to the set (of vectors in the feature space 303) in which both metrics simultaneously have a (sub)critical value. Alternatively, the set of the near-miss events can also be defined as the set in which at least one metric has a (sub)critical value. The near-miss events are defined such that near-miss events occur significantly more frequently than damage events, e.g., in the single- or double-digit percent range.
By fitting a probability model (or statistical model) to the data from the control data database 301, the probabilities p(A), p(B), p(A|B) can then be ascertained without the damage event necessarily having to be observed in the data of the control data database 301. Depending on the probability model (e.g., Pareto distribution) and the type of model fitting, confidence intervals for the ascertained probabilities can also be determined.

Instead of using formula (1), the ascertainment 306 as to whether p(A)<ϵ is fulfilled can consist in making plausible that the probability p(A) of a damage event in the system under test is not greater than that of the (e.g., similar) system for which the data of the control data database 301 were collected, provided that no damage event occurred for the latter. This can be done in multiple ways or in multiple steps on the basis of the probability of occurrence of a near-miss event, in particular p(B) (i.e., according to various criteria by means of which a limitation of the probability of a critical event can be inferred from a limitation of the probability (of occurrence) of a subcritical event).

According to one embodiment, as described above, in a first stage, if p(B)>δ, a risk-mitigating safety measure 205 is first triggered and, in a second stage, a decision is made as to whether the particular driving function can generally remain activated, for example as follows:
At runtime: Determination of the relative frequency of the near-miss events (i.e., an estimation of p(B)), which is possible due to the increased probability of occurrence in comparison to the damage events. If it turns out that a near-miss event occurs significantly more frequently than in a similar system (for which the data of the control data database 301 were collected), the system under test (e.g., the driving function) is deactivated and a switch to a safety system (e.g., a previous version) is carried out.
Alternatively or additionally, the probability model fitted to the data of the control data database 301 can also be used directly to assess observation representations (in particular those in the near-miss domain 305) with regard to the probability of occurrence of a near-miss event even before a first stable estimate for p(B) is present in the system under test, which allows a risk-mitigating safety measure 205 to be triggered even earlier, e.g., a fallback to safe operation (e.g., control by a fallback safety system or manual control by a user).
Alternatively or additionally, instead of a probability model fitted to the data of the control data database 301, the distance of observation representations (in particular those in the near-miss domain 305) from the damage domain 304 can also be used to assess whether the driving function should be deactivated.

For example, it turns out that the near-miss events that occur are already dangerously close to an actual damage event (i.e., the instantaneous p(A|B) extrapolated from live observations is significantly higher than that ascertained using large statistics). In this case, the driving function is also deactivated.
At regular intervals (e.g., overnight or, if there is sufficient computing capacity, also at runtime), (probability) model fitting can again be carried out on the basis of the observations recorded in the system under test. Provided that there are significant deviations from the probability model fitted to the data of the control data database 301 and/or an unacceptably high estimate for p(A) and/or for p(A|B) in the system under test, a permanent switch to safe operation can be carried out, for example. As part of quality control and field observation, the data recorded during operation or at least the newly fitted probability model can be transmitted back to a user or developer for further evaluation.
If the probability model is adjusted on the basis of the observations recorded in the system under test, this can lead to a shift in the final effect p(A|B) and thus the acceptance threshold δ. If this acceptance threshold moves into a range that can no longer be reasonably fulfilled, or if the driving function is thereby classified as too dangerous, the driving function is deactivated again.

If the ascertainment 306 is on the basis of the test as to whether p(B)<δ, the limit δ and a confidence η is determined in this respect. At runtime, observations (and thus statistical evidence) are collected for the proxy hypothesis, e.g., on the basis of consistency and plausibility tests, and are mapped into the feature space 303. There, a classification is carried out (online) into observation representations for near-miss events and for “normal” (i.e., neither near-miss event nor damage event). An aggregation of the classification result is carried out, for example, in the form of a binomial subjective logic opinion ω(b,d,u,a), wherein b results from the observation representations classified as “normal”, d from the observation representations for near-miss events, and u from the total number of observation representations. The statistical prior a is in turn generated on the basis of prior knowledge, which is derived either from expert knowledge or from the analysis of the data of the control data database 301. By means of the bijective mapping of subjective logic, ω is mapped onto the corresponding beta distribution. Provided that the condition

$${\int }_{0}^{δ} {β}_{ω} ( p ) dp > η \qquad ( 2 )$$

is fulfilled, the proxy hypothesis can be confirmed with sufficient confidence and is therefore accepted. Otherwise, a risk-mitigating system response 305 is triggered. In order to save runtime, a lookup table can be pre-calculated (offline), which assigns a label “condition fulfilled” or “not fulfilled” to a subjective logic opinion.

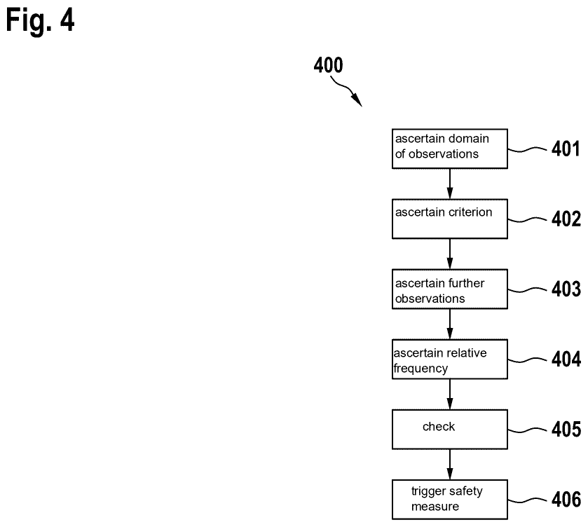

In summary, according to various embodiments, a method is provided as shown in FIG. 4.

FIG. 4 shows a flowchart 400, which represents a method for controlling a robotic apparatus according to an embodiment.

In 401, a domain of observations made during subcritical events is ascertained from observations (offline observations) during controls performed in particular control situations, from a control data database. The database contains information for each control or control situation as to whether a subcritical or critical event has occurred.

In 402, a criterion is ascertained from the observations from the control data database, by means of which criterion a limitation of the probability of occurrence of a critical event can be inferred from a limitation of the probability of occurrence of a subcritical event (e.g., on the basis of a ratio of subcritical events to critical events in the controls for which the control data database contains data).

In 403, further observations (online observations) are ascertained when controlling the robotic apparatus and, in 404, a relative frequency of those of the further observations that are in the ascertained domain (among the further observations) is ascertained.

In 405, it is checked whether the ascertained relative frequency corresponds to a probability of occurrence of a subcritical event (i.e., the ascertained frequency is used as an estimate of the probability of occurrence) that is limited in such a way that, according to the criterion, a limitation of the probability of occurrence of a critical event can be inferred therefrom.

In 406, a safety measure is triggered in response to the ascertained frequency not corresponding to a probability of occurrence of a subcritical event that is limited in such a way that a limitation of the probability of occurrence of a critical event can be inferred therefrom according to the criterion.

The method of FIG. 4 can be performed by one or more computers with one or more data processing units (e.g., by the computer system 105, which, for example, handles the processing of the offline observations, and the vehicle control device 102, which, for example, handles the processing of the online observations). The term “data processing unit” may be understood as any type of Entity that allows for processing of data or signals. The data or signals can be treated, for example, according to at least one (i.e., one or more than one) specific function which is carried out by the data processing unit. A data processing unit can comprise or be formed from an analog circuit, a digital circuit, a logic circuit, a microprocessor, a microcontroller, a central processing unit (CPU), a graphics processing unit (GPU), a digital signal processor (DSP), an integrated circuit of a programmable gate array (FPGA), or any combination thereof. Any other way of implementing the particular functions described in more detail herein may also be understood as a data processing unit or logic circuit assembly. One or more of the method steps described in detail here can be executed (e.g., implemented) by a data processing unit by one or more specific functions that are carried out by the data processing unit.

The method is therefore in particular computer-implemented according to various embodiments.

The approach of FIG. 4 is used to generate a control signal for a robotic apparatus. The term “robotic apparatus” may be understood to mean any technical system (comprising a mechanical part of which the movement is controlled), such as a computer-controlled machine, a vehicle, a robotic arm, a household appliance, a power tool, a manufacturing machine, a personal assistant, or an access control system.

Various embodiments may receive and use sensor signals from various sensors, such as video, radar, LIDAR, ultrasound, motion, thermal imaging, etc., for example in order to detect a corresponding control situation. The sensor data can be processed. This can comprise the classification of the sensor data or the performance of a semantic segmentation of the sensor data, for example in order to detect the presence of objects (in the environment in which the sensor data were obtained).

What is claimed is:

1. A method for controlling a robotic apparatus, comprising the following steps:
ascertaining a domain of observations made during subcritical events, from observations of controls performed in corresponding control situations, from a control data database;
ascertaining, from the observations from the control data database, a criterion using which a limitation of a probability of occurrence of a critical event can be inferred from a limitation of a probability of occurrence of a subcritical event;
ascertaining further observations when controlling the robotic apparatus, and ascertaining a relative frequency of those of the further observations that are in the ascertained domain;
checking whether the ascertained relative frequency corresponds to a probability of occurrence of a subcritical event that is limited in such a way that, according to the criterion, a limitation of the probability of occurrence of a critical event can be inferred therefrom; and
triggering a safety measure in response to the ascertained frequency not corresponding to a probability of occurrence of a subcritical event that is limited in such a way that a limitation of the probability of occurrence of a critical event can be inferred therefrom according to the criterion.

2. The method according to claim 1, wherein the criterion is a conditional probability that a critical event occurs when a subcritical event occurs.

3. The method according to claim 2, further comprising:
ascertaining the conditional probability from a distribution of critical events and subcritical events across controls for which the control data database contains data.

4. The method according to claim 2, further comprising providing a subjective logic opinion from the relative frequency, wherein the criterion is a criterion regarding the subjective logic opinion and depending on the conditional probability.

5. The method according to claim 1, wherein the observations from the control data database do not contain any observations for critical events and the criterion is that the ascertained relative frequency does not exceed, by more than a specified tolerance, a relative frequency with which the observations from the control data database contain observations for subcritical events.

6. The method according to claim 1, wherein the ascertaining of the domain of observations made during subcritical events includes mapping the observations into a feature space and ascertaining a domain of the feature space into which observations made during subcritical events are mapped, and ascertaining a relative frequency of those of the further observations that are in the ascertained domain by mapping the further observations into the feature space and ascertaining the relative frequency of those of the further observations that are mapped into the ascertained domain of the feature space.

7. The method according to claim 1, wherein the robotic apparatus is a vehicle, and the control situation is a traffic situation.

8. A data processing system configured to perform a method for controlling a robotic apparatus, the method including the following steps:
ascertaining a domain of observations made during subcritical events, from observations of controls performed in corresponding control situations, from a control data database;
ascertaining, from the observations from the control data database, a criterion using which which a limitation of a probability of occurrence of a critical event can be inferred from a limitation of a probability of occurrence of a subcritical event;
ascertaining further observations when controlling the robotic apparatus, and ascertaining a relative frequency of those of the further observations that are in the ascertained domain;
checking whether the ascertained relative frequency corresponds to a probability of occurrence of a subcritical event that is limited in such a way that, according to the criterion, a limitation of the probability of occurrence of a critical event can be inferred therefrom; and
triggering a safety measure in response to the ascertained frequency not corresponding to a probability of occurrence of a subcritical event that is limited in such a way that a limitation of the probability of occurrence of a critical event can be inferred therefrom according to the criterion.

9. A non-transitory computer-readable medium on which are stored commands for controlling a robotic apparatus, the commands, when executed by a processor, causing the processor to perform the following steps:
ascertaining a domain of observations made during subcritical events, from observations of controls performed in corresponding control situations, from a control data database;
ascertaining, from the observations from the control data database, a criterion using which which a limitation of a probability of occurrence of a critical event can be inferred from a limitation of a probability of occurrence of a subcritical event;
ascertaining further observations when controlling the robotic apparatus, and ascertaining a relative frequency of those of the further observations that are in the ascertained domain;
checking whether the ascertained relative frequency corresponds to a probability of occurrence of a subcritical event that is limited in such a way that, according to the criterion, a limitation of the probability of occurrence of a critical event can be inferred therefrom; and
triggering a safety measure in response to the ascertained frequency not corresponding to a probability of occurrence of a subcritical event that is limited in such a way that a limitation of the probability of occurrence of a critical event can be inferred therefrom according to the criterion.
